(19) United States
(12) Patent Application Publication
(10) Pub. No.: US 2013/0054527 A1
(43) Pub. Date: Feb. 28, 2013

(54) TERMINAL, SERVER, AND METHOD FOR SYNCHRONIZING APPLICATION

(71) Applicants: Jeong Joon HWANG, Seoul (KR); Yun Seop Geum, Seoul (KR)

(72) Inventors: Jeong Joon HWANG, Seoul (KR); Yun Seop Geum, Seoul (KR)

(73) Assignee: PANTECH CO., LTD., Seoul (KR)

(21) Appl. No.: 13/584,636

(22) Filed: Aug. 13, 2012

(30) Foreign Application Priority Data
Aug. 29, 2011 (KR) 10-2011-0086283

(51) Int. Cl. G06F 17/30

(52) U.S. Cl. 707/634; 707/E17.005; 707/E17.032

(57) ABSTRACT

A terminal, includes: a communication unit to communicate with a synchronization server and a market; a short-range communication unit to communicate with a second terminal; and a controller to control the terminal, wherein the communication unit receives an application from the market, and communicates a request to the synchronization server to synchronize the application with the second communication terminal. A method for synchronizing an application, includes: transmitting, from a first communication terminal, information about an application to a synchronization server; searching for a second communication terminal associated with the first communication terminal; and retrieving a second application from a market based on the information about the application.

### CROSS-REFERENCE TO RELATED APPLICATION

This application claims priority from and the benefit under 35 U.S.C. §119(a) of Korean Patent Application No. 2011-0086283, filed on Aug. 29, 2011, which is incorporated by reference for all purposes as if fully set forth herein.

### BACKGROUND

1. Field

Exemplary embodiments of the present invention relate to a terminal, server and method for synchronizing applications.

2. Discussion of the Background

With the development of information communication technology, a smart phone has come into use which integrates data communication with a mobile phone.

The smart phone allows a user to install, add or delete various applications (application programs).

In addition to the smart phone, various communication terminals that integrate data communication, such as a smart television (TV), a vehicle navigation system and a tablet personal computer (PC), and the like, have been developed.

In various communication terminals that integrate data communication, such as the smart phone, an operating system (OS) may be included with network capabilities that allow for obtaining an application through a network for installation.

A user may have more than one communication terminal. To install the same application in more than one communication terminal, the user may individually download and install a specific application to all, or some, of the communication terminals. More specifically, the user may access a source for the application, such as a market (an online content market for selling various applications), search for the specific application, download the searched specific application, and repeat this process for one or more additional communication terminal the user has.

For example, for a user who has a smart phone, a smart TV, a vehicle navigation system and a tablet PC to download and install an application A to each of these communication terminals, the user may access a market, searches for the application A in the accessed market, downloads and installs the searched application A in each of the communication terminals. More specifically, with respect to the smart phone, smart TV, the vehicle navigation system and the tablet PC, the user may repeat this process, and thus accesses the market, searches for the application A in the accessed market, and downloads and installs the searched application A, for each of the respective communication terminals.

### SUMMARY

Exemplary embodiments of the present invention provide a terminal, server and method for synchronizing applications, and specifically, a technique to allow the sharing of applications between various user devices that access a server or market to retrieve and acquire applications.

Additional features of the invention will be set forth in the description which follows, and in part will be apparent from the description, or may be learned by practice of the invention.

An exemplary embodiment of the present invention discloses a terminal, comprising: a communication unit to communicate with a synchronization server and a market; a short-range communication unit to communicate with a second terminal; and a controller to control the terminal, wherein the communication unit receives an application from the market, and communicates a request to the synchronization server to synchronize the application with the second communication terminal.

An exemplary embodiment of the present invention discloses a synchronization server, including: a communication unit to communicate with a first communication terminal and a market; a database to store a table corresponding terminals with applications; a database search unit to search the database; and a controller to control the synchronization server, wherein the communication unit receives a request from the first communication terminal to synchronize the application.

An exemplary embodiment of the present invention discloses a method for synchronizing an application, including: transmitting, from a first communication terminal, information about an application to a synchronization server; searching for a second communication terminal associated with the first communication terminal; and retrieving a second application from a market based on the information about the application.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an application synchronization system according to an exemplary embodiment of the present invention.

FIG. 2 is a diagram illustrating an application synchronization system according to an exemplary embodiment of the present invention.

FIG. 3 is a diagram illustrating a communication terminal according to an exemplary embodiment of the present invention.

FIG. 4 is a diagram illustrating a synchronization server according to an exemplary embodiment of the present invention.

FIG. 5 is a diagram illustrating a structure of a database according to an exemplary embodiment of the present invention.

FIG. 6 is a flowchart illustrating a method for synchronizing applications according to an exemplary embodiment of the present invention.

FIG. 7 is a flowchart illustrating a method for synchronizing applications according to an exemplary embodiment of the present invention.

FIG. 8 is a flowchart illustrating a method for synchronizing applications according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

In this disclosure, a user may have a multiple number of communication terminals. For example, in some of the descriptions disclosed below, a user may have three communication terminals, such as (e.g., a smart phone, a table PC and a smart TV. A first communication terminal (e.g., the smart phone) downloads an application from a market A, a second communication terminal (e.g., the tablet PC) downloads an application from a market B, and a third communication terminal (e.g., the smart TV) downloads an application from a market C. In the numerous examples disclosed below, a user may be in possession of the multiple terminals.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

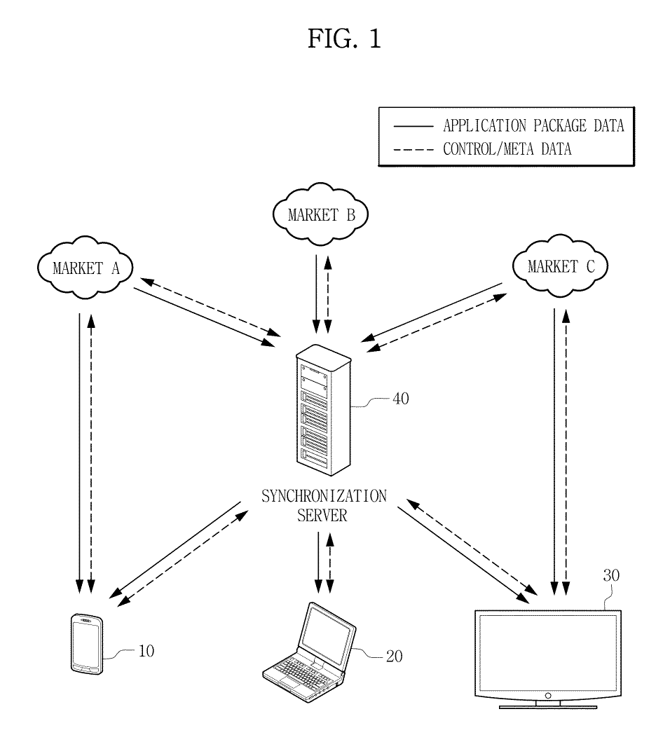

FIG. 1 is a diagram illustrating an application synchronization system according to an exemplary embodiment of the present invention.

Referring to FIG. 1, the first communication terminal 10 accesses a market A. Market A may refer to an online content market that sells or provides an application. Market A may allow a user to search for an application, and the user may download and install the searched for application to terminal 10. A user may make a request to a synchronization server 40 and market A may transmit information about the application to the synchronization server 40.

The first communication terminal 10 may store information, such as, a telephone number, identification information, or a serial number (S/N) about the other communication terminals (e.g., a second communication terminal and a third communication terminal) in a memory region. The first communication terminal 10 may search to find the other communication terminals via short-range communication based on the information stored in the memory region. The first communication terminal 10 may also determine if the information about the application is transmitted to the synchronization server 40, and determine if the other communication terminals retrieved from the search are capable of communicating with the synchronization server 40. For example, if the second communication terminal 20 may not perform communication with the synchronization server 40, the application to be downloaded to the second communication terminal 20 may be downloaded from the synchronization server 40 using device information (e.g., hardware/software information) of the second communication terminal 20 to another terminal, such as a first communication terminal 10 or a third communication terminal 30, and the downloaded application may be transmitted to the second communication terminal 20 via short-range communication.

The device information may include at least one of hardware information and software information of a communication terminal that may be used to search for a market that sells or provides applications suitable for the communication terminal. For example, the device information may include information, such as an operating system and a terminal type.

If the second communication terminal 20 may not perform communication with the synchronization server 40, the first communication terminal 10 may access market B, which may sell or provide applications suitable for the second communication terminal 20, searches for the application in market B, downloads the application to the first communication terminal 10, and transmits the application to the second communication terminal 20 via short-range communication.

If the information about the application is received by the synchronization server 40 from the first communication terminal 10, the synchronization server 40 may search for other communication terminals, such as, the second communication terminal 20 and the third communication terminal 30. The synchronization server 40 may access market B that may sell or provide applications suitable for the second communication terminal 20, searches for an application in market B that may be downloaded to the second communication terminal 20 based on the information about the application, download the application, and transmit the application to the second communication terminal 20. The synchronization server 40 may also access market C, that may sell or provide applications suitable for the third communication terminal 30, searches for an application in market C that may be downloaded to the third communication terminal 30 based on the information about the application, download the application, and transmit the application to the third communication terminal 30. The synchronization server 40 may transmit link information that allows a user or terminal to download the applications, and not transmit the applications (or application package) to the second communication terminal 20 and the third communication terminal 30.

The synchronization server 40 may store the applications (or link information) downloaded from the respective markets if communication with the second communication terminal 20 and the third communication terminal 30 is not established. Further, the synchronization server 40 may transmit the applications (or link information) to the second communication terminal 20 and the third communication terminal 30 if communication is established.

As described above, the second communication terminal 20 and the third communication terminal 30, which may receive the applications (or the link information) from the synchronization server 40 may install the applications (or the link information) received from the synchronization server 40, automatically or if the user allows the installation of the applications.

If the information about the application is received from the first communication terminal 10, the synchronization server 40 may search for other communication terminals associated with the user of the first communication terminal 10, such as, the second communication terminal 20 and the third communication terminal 30, and transmits the information about the application received from the first communication terminal 10 to the searched second communication terminal 20 and third communication terminal 30.

The second communication terminal 20 and third communication terminal 30, which may receive the information about the application from the synchronization server 40, respectively access the market B and the market C, search for applications based on the information about the application received from the synchronization server 40, download the applications, and install the applications.

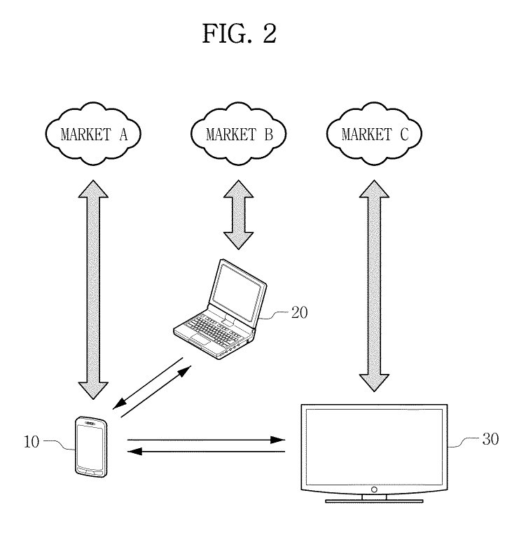

FIG. 2 is a diagram illustrating an application synchronization system according to an exemplary embodiment of the present invention.

Referring to FIG. 2, the first communication terminal 10 accesses the market A for an application requested by the user, downloads the application, and installs the application. Further, the first communication terminal 10 may search to find other communication terminals associated with the user via short-range communication based on a request to synchronize applications, and transmits the information about the downloaded application to the other communication terminals (e.g., the second communication terminal and third communication terminal) via short-range communication. The first communication terminal 10 may store information, such as, a telephone number, identification information, a serial number (S/N) about the other communication terminals in a memory region, and may search for the other communication terminals via short-range communication based on the information about the other communication terminals stored in the memory region, if a request to synchronize is made.

The first communication terminal 10 checks the communication state of the communication terminals (e.g., the second communication terminal and third communication terminal) searched via short-range communication with the respective markets, accesses market B based on device information (e.g., hardware/software information) of the second communication terminal 20 acquired from the second communication terminal 20. For example, if the second communication terminal 20 may not communicate with market B, the first communication terminal 10 may search for the application based on the information about the application in the market B, downloads the searched for application, and transmits the application to the second communication terminal 20 via short-range communication. A similar process may be performed with the third communication terminal 30.

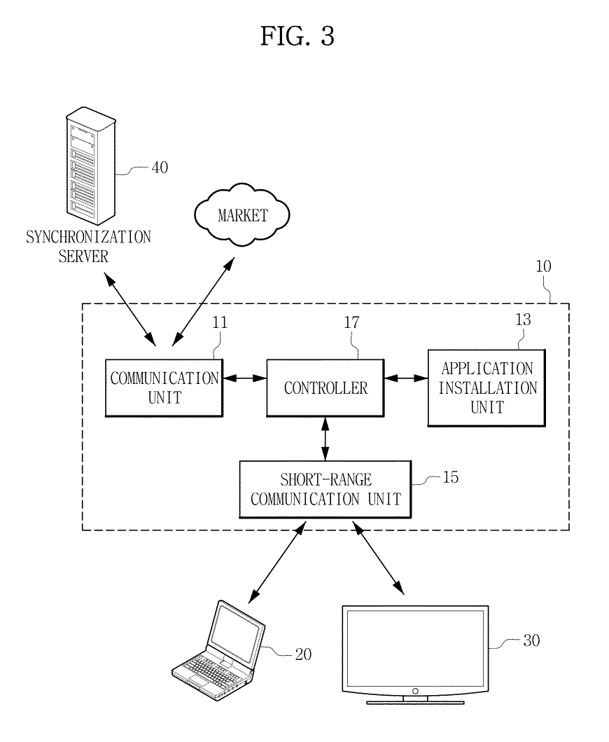

FIG. 3 is a diagram illustrating a communication terminal according to an exemplary embodiment of the present invention.

Referring to FIG. 3, a communication unit 11 communicates with a market (e.g., the market A, B, or C) and communicates with the synchronization server 40 to synchronize the application, under the control of a controller 17.

An application installation unit 13 installs the application downloaded from the market.

A short-range communication unit 15 searches for other communication terminals (e.g., the second communication terminal and the third communication terminal) that may be associated with the user of the first communication terminal 10 via short-range communication.

The controller 17 searches for and downloads the application requested by the user from the market and transmits the information associated with the downloaded application to the synchronization server 40.

The controller 17 transmits the information associated with the application to the synchronization server 40, searches for other communication terminals associated with the user via the short-range communication unit 15. The search may be based on information, such as, a telephone number, identification information, a serial number (S/N) stored in the memory region, and checks the communication state of the searched communication terminals with the synchronization server 40. If the second communication terminal 20 may not communicate with the synchronization server 40, an application to be downloaded to the second communication terminal 20 may be downloaded from the synchronization server 40 to the first communication terminal 10 based on device information (e.g., hardware/software information) of the second communication terminal 20 acquired from the second communication terminal 20, and the downloaded application may be transmitted to the second communication terminal 20 via short-range communication.

Since the configuration and operation of the first communication terminal 10 may be similar to those of the second communication terminal 20, and the third communication terminal 30, descriptions of the same elements will be omitted. However, one of ordinary skill in the art would be able to apply and implement similar elements as disclosed and associated with the first communication terminal 10, in the second communication terminal 20 and the third communication terminal 30.

The controller 17 of the first communication terminal 10 may determine the communication state of the other communication terminals searched via the short-range communication unit 15 with the synchronization server 40, access market B based on device information (e.g., hardware/software information) of the second communication terminal 20 acquired from the second communication terminal 20. For example, if the second communication terminal 20 may not communicate with the synchronization server 40, the controller 17 of the first communication terminal 10 may control the terminal to search for the application in the market B based on the information about the application, download the searched application, and transmit the application to the second communication terminal 20 via short-range communication.

The controller 17 may search for and download an application requested by the user in a market (e.g., the market A) accessed via the communication unit 11, and transmit information about the downloaded application to other communication terminals (the second and third communication terminals)identified or found through a search performed via short-range communication unit 15.

The controller 17 may determine the communication state of the other communication terminals with the synchronization server 40, access a market capable of providing applications for the retrieved communication terminals based on device information (e.g., hardware/software information) of the other communication terminals. If the second communication terminal 20 may not communicate with the synchronization server 40, the first communication terminal 10 may search for or identify the application in the market B based on the information about the application, download the application, and transmits the retrieved application to at least one of the other communication terminals via short-range communication.

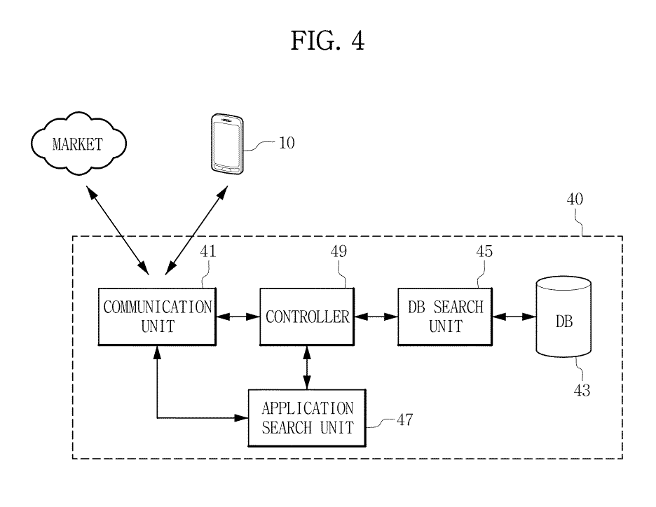

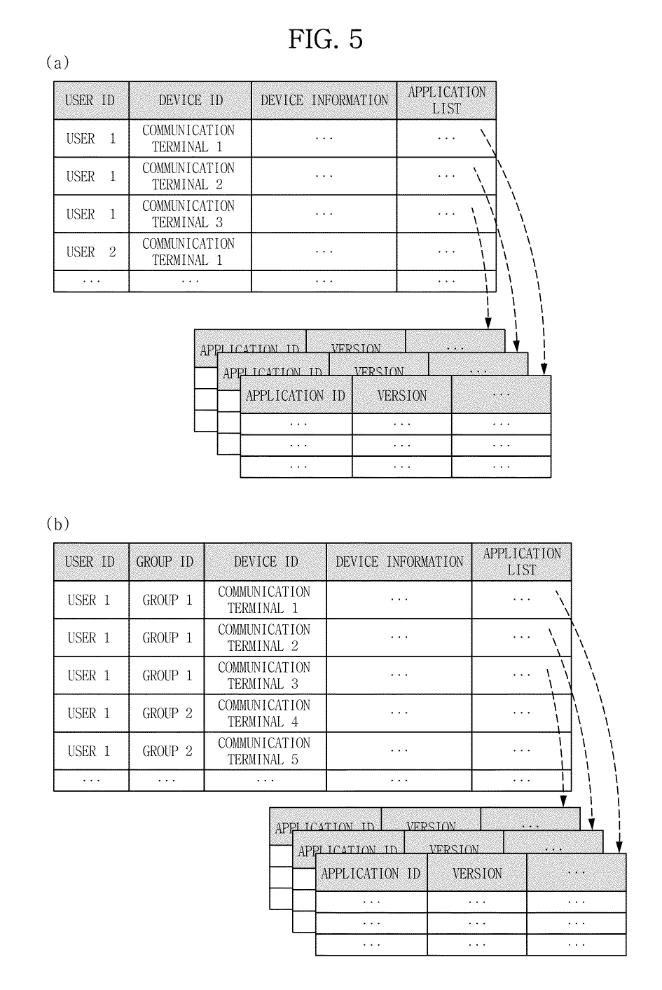

FIG. 4 is a diagram illustrating a synchronization server according to an exemplary embodiment of the present invention. FIG. 5 is a diagram illustrating the structure of a database according to an exemplary embodiment of the present invention.

Referring to FIG. 4, a communication unit 41 communicates with the first communication terminal 10 and synchronizes an application, and communicates with a market.

A database 43 may store identification and device information (e.g., hardware/software information) of a plurality of communication terminals associated with the user and store a list of applications installed in the communication terminals on a per user basis, as shown in FIG. 5(a). The device information may include at least one of hardware information and software information of the communication terminal used to search to identify a market, which may sell or provide an application requested by the user. The device information may include, without limitation, an operating system and a terminal type. The hardware information and software information may be utilized in searching for an appropriate market, which may provide the requested application. In addition to basic information of the applications installed in the communication terminals, information indicating whether an application has been installed, is to be installed, or has been removed is stored along with the list of applications.

As described above, synchronization of an application may be performed between two or more communication terminals associated with a user. However, one of ordinary skill in the art may incorporate the aspects disclosed herein to, without limitation, communication terminals commonly owned by friends, family, colleagues and club members or users that may be classified into various groups. In this case, as shown in FIG. 5(b), identification of the groups classified by the user on a per user basis may be stored in the database 43, and at least one of identification information and device information (e.g., hardware/software information) of the plurality of communication terminals belonging to each group may also be stored. If the synchronization group is classified into a plurality of groups, if requesting application synchronization, the user may select a group and the application that will be synchronized.

A database search unit 45 may search the database 43 to identify other communication terminals associated with the user, based on a request to synchronize applications between the various terminals. Various components of the synchronization server 40 may be controlled by controller 49.

An application search unit 47 may access the markets based on device information (e.g., hardware/software information) of the other communication terminals associated with the user and searches for an application requested by the user based on information about the application.

If the information about the application is received from the first communication terminal 10, and the user of the communication terminal 10 requests a synchronization of the application with one of the other communication terminals, the controller 49 may search to find other communication terminals associated with the user via the database search unit 45, search for the applications to be downloaded to the found communication terminals via the application search unit 47, download the applications, and transmits the applications to at least one of the found communication terminals (e.g., the second and third communication terminals).

If the information about the application is received from the first communication terminal 10, the controller 49 may search to find other communication terminals associated with the user via the database search unit 45, and transmits the information about the application to at least one of the other communication terminals (e.g., the second and third communication terminals).

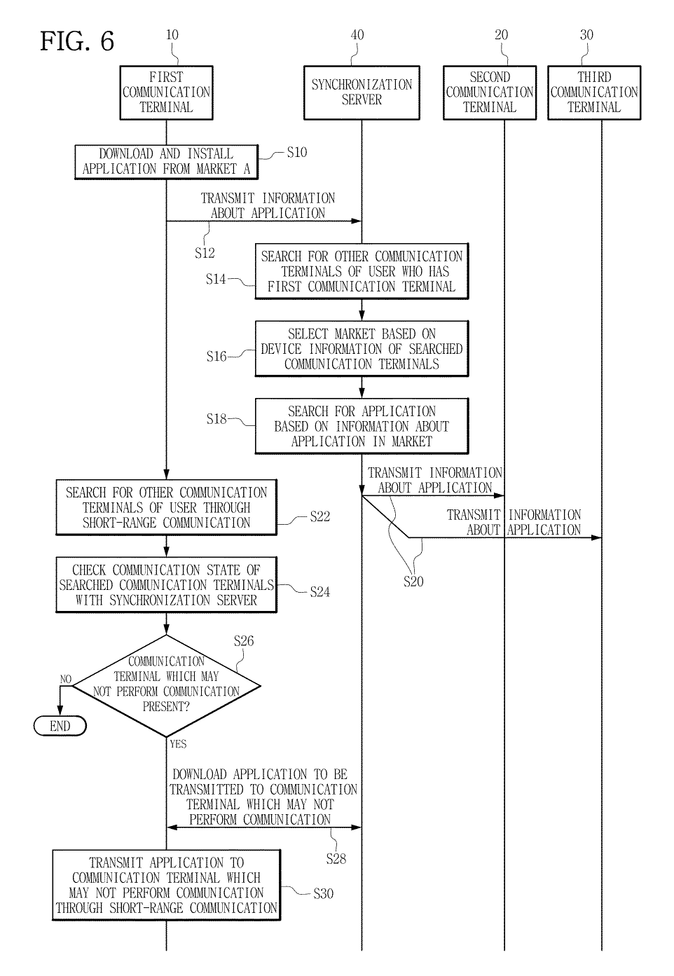

FIG. 6 is a flowchart illustrating a method for synchronizing applications according to an exemplary embodiment of the present invention. The method of FIG. 6 below will be described as if performed by the first communication terminal 10 of FIG. 3 and the synchronization server 40 of FIG. 4, but are not limited as such.

First, the first communication terminal 10 downloads and installs an application requested by the user from market A. The user may be associated with the first communication terminal 10, the second communication terminal 20, and the third communication terminal 30 (S10).

The first communication terminal 10 transmits information about the application (i.e., information about the downloaded application) to the synchronization server 40, and the user of the first communication terminal 10 may request application synchronization (S12).

The synchronization server 40 searches a database 43 to find other communication terminals associated with the user of the first communication terminal 10and requests application synchronization (S14). The search operation S14 may be performed by using identification information associated with the user of the first communication terminal 10.

Markets associated with other communication terminals, such as market B for the second communication terminal 20 or market C for the third communication terminal 30, may be selected based on device information (e.g., hardware/software information) of the other communication terminals (S16), and the selected markets are accessed and the applications are searched for based on the information about the application received from the first communication terminal 10 (S18).

The applications searched for in operation S18 are transmitted to other communication terminals found in operation S14 (S20).

If communication with the other communication terminal is established, the synchronization server 40 transmits the applications corresponding to the other communication terminals, and the applications are transmitted to the corresponding communication terminals to be installed. However, if communication is not established for at least one of the other communication terminals, the application and the identification of the communication terminal corresponding to the communication terminal that is unable to establish communication may be stored in the database 43 in order to transmit the applications if communication is established.

The second communication terminal 20 and the third communication terminal 30, which receive the applications from the synchronization server 40, install the applications received from the synchronization server 40, automatically or based on a request by the user.

The first communication terminal 10 searches for the other communication terminals via short-range communication (S22).

In searching for other communication terminals associated with the user, the first communication terminal may use various techniques or information, such as a telephone number, identification information, and a serial number (S/N) about the other communication terminals.

The communication state of the other communication terminals with the synchronization server 40 is determined (S24).

If another communication terminal may not communicate with the synchronization server 40, for example, the second communication terminal 20, the application to be downloaded to the second communication terminal 20 is downloaded to the first communication terminal 10 from the synchronization server 40 based on device information (e.g., hardware/software information) of the second communication terminal 20 (S26 and S28).

The application downloaded from the synchronization server 40 is transmitted to the second communication terminal 20 via short-range communication (S30).

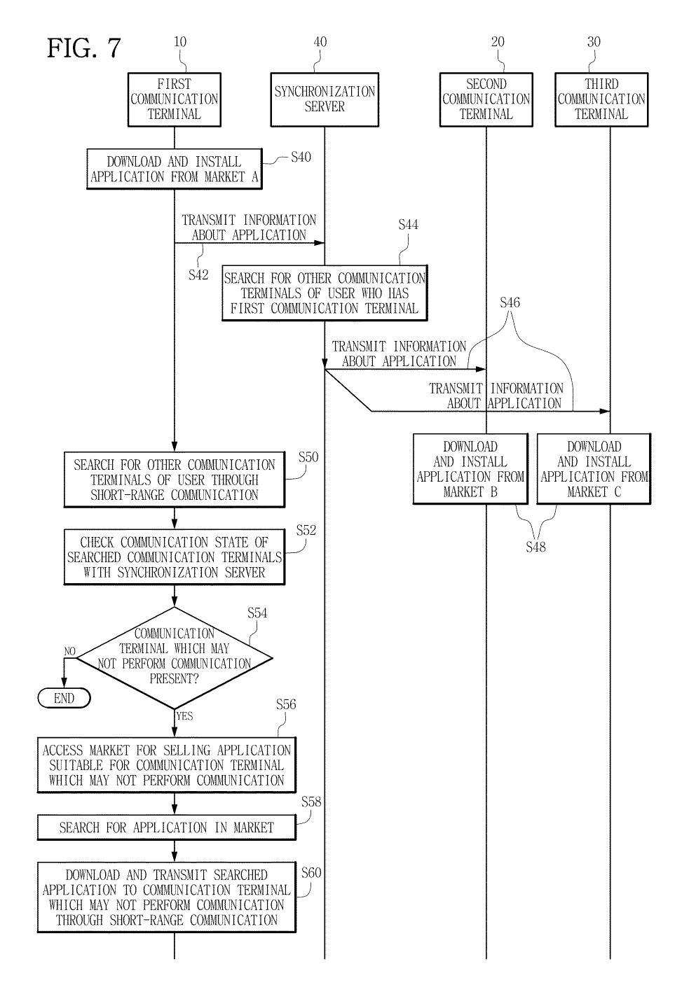

FIG. 7 is a flowchart illustrating a method for synchronizing applications according to an exemplary embodiment of the present invention. The method of FIG. 7 below will be described as if performed by the first communication terminal 10 of FIG. 3 and the synchronization server 40 of FIG. 4, but are not limited as such.

The first communication terminal 10 downloads and installs an application requested by a user of the first communication terminal 10 from market A (S40).

The first communication terminal 10 transmits information about the application (information about the downloaded application) to the synchronization server 40 based on a request to synchronize the application (S42).

The synchronization server 40 searches the database 43 for other communication terminals associated with the user (S44). The synchronization server 40, while performing the search for other communication terminals, may use information pertaining to the identification of the user of the first communication terminal 10.

Thereafter, the information about the application received from the first communication terminal 10 is transmitted to the other communication terminals (S46).

The second communication terminal 20 and the third communication terminal 30, which may correspond to the search for communications terminals, respectively access the market B and market C, search for the applications based on the information about the application, and download and install the searched applications (S48).

The first communication terminal 10 via short-range communication (S50) and determines the communication state of the other communication terminals (e.g., the second and third communication terminals) with the synchronization server 40 (S52).

If another communication terminal may not communicate with the synchronization server 40, as determined in Operation S52, a first communication terminal 10 accesses the market B based on device information (hardware/software information) of the second communication terminal 20 acquired from the second communication terminal 20 (S54 and S56), and the application is searched for in the market B based on the information about the application (S58), and the searched application is downloaded and transmitted to the second communication terminal 20 through short-range communication (S60). A similar process may occur with respect to the third communication terminal 30, or any other communication terminal in which the user requests synchronization of applications with.

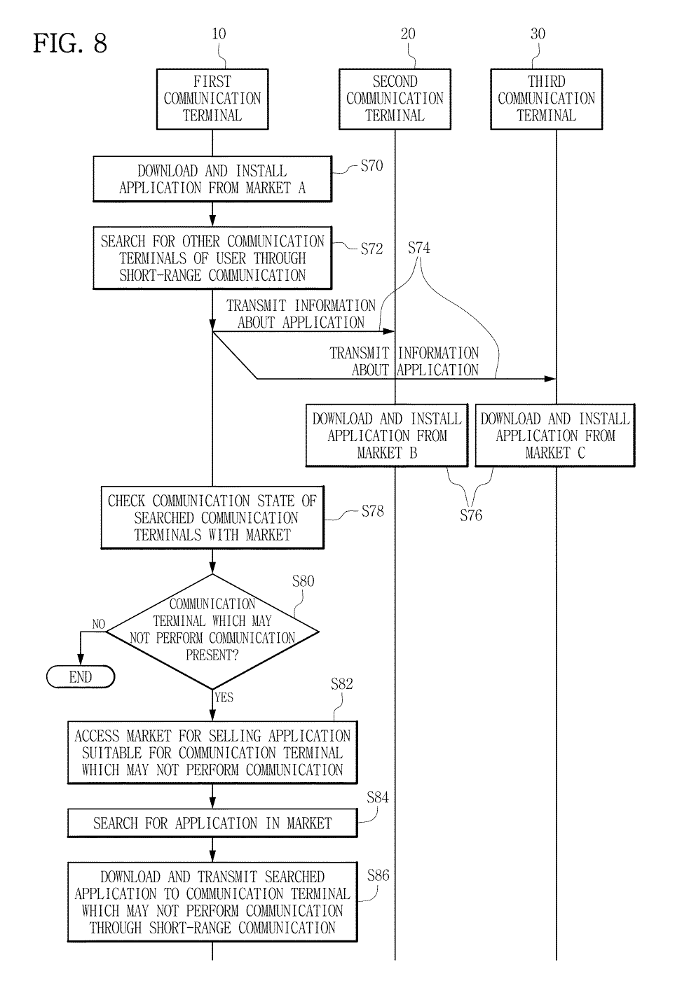

FIG. 8 is a flowchart illustrating a method for synchronizing applications according to an exemplary embodiment of the present invention.

The first communication terminal 10 downloads and installs an application requested by a user of the first communication terminal 10 from the market A (S70).

The first communication terminal 10 searches for the other communication terminals via short-range communication (S72) and transmits the information about the application to the other communication terminals (S74).

The second communication terminal 20 and the third communication terminal 30, which may correlate to the other communication terminals, receive the information about the application from the first communication terminal 10, respectively access the market B and market C, and search for the applications based on the information about the application, and download and install the searched applications (S76).

The first communication terminal 10 determines the communication state of the other communication terminals with their respective markets (S78).

If a communication terminal, for example, the second communication terminal 20, may not establish communication with its respective market, the first communication terminal 10 may access market B based on device information (hardware/software information) of the second communication terminal 20 acquired from the second communication terminal 20 (S80 and S82). The application is searched for in market B based on the information about the application (S84), and the searched application is downloaded and transmitted to the second is communication terminal 20 via short-range communication (S86).

According to an application synchronization system and method disclosed herein, it is possible to transmit and synchronize an application downloaded to a specific communication terminal to another communication terminal by the operations disclosed herein without a separate or extra search process.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A first terminal, comprising:
a communication unit to communicate with a synchronization server and a market;
a short-range communication unit to communicate with a second terminal; and
a controller to control the terminal,
wherein the communication unit receives an application from the market, and communicates a request to the synchronization server to synchronize the application with the second communication terminal.

2. The terminal according to claim 1, wherein the short-range communication unit searches to find the second terminal, and
the controller determines if the second terminal communicates with the synchronization server.

3. The terminal according to claim 2, wherein if the controller determines the second terminal is unable to establish communication with the synchronization server, the short-range communication unit transmits the application to the second terminal.

4. The terminal according to claim 2, wherein if the controller determines the second terminal establishes communication with the synchronization server, the communicating unit transmits to the synchronization server a request to transmit information about the application to the second terminal.

5. The terminal according to claim 2, wherein if the controller determines the second terminal is unable to establish communication with the synchronization server, the communication unit terminal accesses a second market using information of first application to a synchronization server;
identifying a second communication terminal associated with the first communication terminal; and
retrieving a second application from a market based on the information about the first application.

6. The terminal according to claim 5, wherein the communication unit transmits the application to the second terminal.

7. A synchronization server, comprising:
a communication unit to communicate with a first communication terminal and a market;
a database to store information corresponding to communication terminals with applications;
a database search unit to search the database; and
a controller to control the synchronization server,
wherein the communication unit receives a request from the first communication terminal to synchronize the application.

8. The server according to claim 7, wherein the controller determines if a second terminal is of a same group as the first terminal, and transmits the application to the second terminal.

9. The server according to claim 8, wherein the application is retrieved from the market.

10. A method for synchronizing an application, comprising:
transmitting, from a first communication terminal, information about a first application to a synchronization server;
searching for a second communication terminal associated with the first communication terminal; and
retrieving a second application from a market based on the information about the first application.

11. The method according to claim 10, further comprising:
determining if a communication is established between the synchronization server and the second communication terminal.

12. The method according to claim 11, wherein if communication is established, transmitting the second application to the second communication terminal.

13. The method according to claim 11, wherein if communication is not established, transmitting the second application to the first communication terminal.

14. The method according to claim 13, further comprising transmitting the second application from the first communication terminal to the second communication terminal.

15. A method for synchronizing a first application, comprising:
transmitting information about the first application from a first communication terminal to a second communication terminal; and
determining if the second communication terminal establishes communication with a market that sources a second application corresponding to the first application.

16. The method according to claim 15, wherein if the second communication terminal does not establish communication with the market,
acquiring information about the second communication terminal, and
downloading the second application from the market based on the acquired information about the second communication terminal.

17. The method according to claim 16, further comprising transmitting the second application from the first communication terminal to the second communication terminal.

18. A method according to claim 15, if the second communication establishes communication with the market,
downloading the second application from the market to the second communication terminal.
